(19) United States
(12) Patent Application Publication
(10) Pub. No.: US 2025/0074813 A1
(43) Pub. Date: Mar. 6, 2025

(54) Conductive Paste

(71) Applicant: Celanese Mercury Holdings Inc., Wilmington, DE (US)

(72) Inventors: Yusuke Tachibana, Yokohama-shi (JP); Paul VerNooy, Hockessin, DE (US)

(21) Appl. No.: 18/815,900

(22) Filed: Aug. 27, 2024

Related U.S. Application Data
(60) Provisional application No. 63/580,781, filed on Sep. 6, 2023.

(51) Int. Cl. C03C 4/14; C03C 3/12; C03C 8/02; C03C 8/16; C03C 8/18; H01M 4/62

(52) U.S. Cl. CPC C03C 4/14; C03C 3/125; C03C 8/02; C03C 8/16; C03C 8/18; H01M 4/624; C03C 2204/00; C03C 2207/00

(57) ABSTRACT

A conductive paste is provided including a conductive material, glass frit and an organic vehicle. The glass frit includes V₂O₅, TeO₂, Bi₂O₃, and Al₂O₃. V₂O₅ is present in an amount of from about 15 wt. % to about 30 wt. % based on the total weight of the glass frit. Articles containing the conductive paste and methods for using the conductive paste are also provided.

### RELATED APPLICATION

The present application is based upon and claims priority to U.S. provisional patent application Ser. No. 63/580,781, having a filing date of Sep. 6, 2023, which is incorporated herein by reference.

### BACKGROUND OF THE DISCLOSURE

Lithium batteries are known to have high energy densities and include a cathode, anode, separator, and electrolyte. The electrolyte is typically a liquid electrolyte solution. However, liquid electrolyte solutions can be flammable and thus, safer battery alternatives are needed. In view of this, solid state batteries have been developed. Solid state batteries include a solid electrolyte and not a liquid electrolyte solution. Solid state batteries can also have increased capacity as compared to liquid electrolyte batteries.

Solid state batteries can be manufactured via different processes. Certain of these processes require electroplating material layers in low pH conditions and sintering material layers at lower temperature conditions. Considering this, a need exists for improved conductive materials that can be fired at lower temperatures and exposed to acidic conditions.

### SUMMARY OF THE DISCLOSURE

In accordance with one embodiment of the present disclosure, provided is a conductive paste including a conductive material, glass frit, and an organic vehicle. The glass frit includes V₂O₅, TeO₂, Bi₂O₃, and Al₂O₃. V₂O₅ is present in an amount of from about 15 wt. % to about 30 wt. % based on the total weight of the glass frit.

In accordance with another embodiment of the present disclosure, provided is a method for forming an article comprising a terminal electrode for a battery. The method includes disposing a conductive paste on the article. The conductive paste includes a conductive material, glass frit, and an organic vehicle. The glass frit includes V₂O₅, TeO₂, Bi₂O₃, and Al₂O₃. V₂O₅ is present in an amount of about 15 wt. % to about 30 wt. %. The method includes heating the conductive paste to a firing temperature less than about 450° C.

In accordance with another embodiment of the present disclosure, provided is a conductive paste including a conductive material, glass frit, and an organic vehicle. The conductive paste exhibits a resistivity of about 3.5 mohm/sq. to less than about 8 mohm/sq. and is acid resistant when fired at a temperature less than 450° C.

Other features and aspects of the present disclosure are set forth in greater detail below.

### BRIEF DESCRIPTION OF THE FIGURES

A full and enabling disclosure of the present disclosure, including the best mode thereof, directed to one of ordinary skill in the art, is set forth more particularly in the remainder of the specification, which makes reference to the appended figures in which:

FIG. 1 is a cross-sectional view of a battery according to one embodiment of the present disclosure;

FIG. 2 is a cross-sectional view of a battery according to one embodiment of the present disclosure; and

FIG. 3 is a flow chart of an example method of forming an electrode according to one embodiment of the present disclosure.

Repeat use of references characters in the present specification and drawing is intended to represent same or analogous features or elements of the disclosure.

### DETAILED DESCRIPTION

It is to be understood by one of ordinary skill in the art that the present discussion is a description of exemplary embodiments only, and is not intended as limiting the broader aspects of the present disclosure.

Generally speaking, the present disclosure is directed to a conductive paste that exhibits excellent adhesion and is acid resistant even when fired at lower firing temperatures (e.g., those under 450° C.). The conductive paste includes conductive material and glass frit in an organic vehicle. The glass frit is a lead-free glass frit that includes V₂O₅, TeO₂, Bi₂O₃, and Al₂O₃. V₂O₅ is present in amounts of about 15 wt. % to about 30 wt. % based on the total weight of the glass frit. The conductive paste can exhibit a resistivity of about 3.5 mohm/sq. to less than about 8 mohm/sq. and is acid resistant when fired at a temperature less than 450° C.

The conductive paste can be applied to a battery (e.g., a solid state battery) and can be fired to form an electrode (e.g., a terminal electrode) thereon. As such, the present disclosure also provides a method for forming a terminal electrode for a battery. The method includes disposing a conductive paste on the article. The conductive paste includes conductive material and glass frit in an organic vehicle. The glass frit is a lead-free glass frit that includes V₂O₅, TeO₂, Bi₂O₃, and Al₂O₃. V₂O₅ is present in amounts of about 15 wt. % to about 30 wt. % based on the total weight of the glass frit. The method includes heating the conductive paste to a firing temperature of less than about 450° C.

Through selective control over the particular nature of the specific concentration of the components of the conductive paste, the present inventors have discovered that the resulting conductive paste can be effectively fired at lower temperatures (e.g., those less than 450° C.), exhibits excellent adhesion, and is acid resistant, despite such low firing temperatures.

Various embodiments of the present disclosure will now be described in more detail.

### I. Conductive Paste

a. Conductive Material

As indicated above, the conductive paste includes a conductive material. The conductive material of the present disclosure is not subject to any special limitation as long as it does not have an adverse effect on the technical effect of the present disclosure. The conductive material can include conductive materials with an electrical conductivity 7.00×10⁶ Siemens(S)/m or higher at 293 Kelvin in an embodiment, 8.50×10⁶ S/m or higher at 293 Kelvin in another embodiment, 1.00×10⁷ S/m or higher at 293 Kelvin in another embodiment, 4.00×10⁷ S/m or higher at 293 Kelvin in another embodiment.

The conductive material can be a metal powder selected from the group consisting of aluminum (Al, 3.64×10⁷ S/m), nickel (Ni, 1.45×10⁷ S/m), copper (Cu, 5.81×10⁷ S/m), silver (Ag, 6.17×10⁷ S/m), gold (Au, 4.17×10⁷ S/m), molybdenum (Mo, 2.10×10⁷ S/m), magnesium (Mg, 2.30×10⁷ S/m), tungsten (W, 1.82×10⁷ S/m), cobalt (Co, 1.46×10⁷ S/m), zinc (Zn, 1.64×10⁷ S/m), platinum (Pt, 9.43×10⁶ S/m), palladium (Pd, 9.5×10⁶ S/m), an alloy thereof and a mixture thereof in an embodiment. The conductive material can be selected from the group consisting of silver, gold, copper, an alloy thereof and a mixture thereof in another embodiment.

In embodiments, the conductive material can be silver. In the case of using silver as the conductive material, it can be in the form of silver metal, silver derivatives and/or the mixture thereof. Examples of silver derivatives include silver oxide (Ag₂O), silver salts (such as silver chloride (AgCl), silver nitrate (AgNO₃), silver acetate (AgOOCCH₃), silver trifluoroacetate (AgOOCCF₃) or silver phosphate (Ag₃PO₄), silver-coated composites having a silver layer coated on the surface or silver-based alloys or the like.

The conductive material can be in the form of powder (for example, spherical shape, flakes, irregular form and/or the mixture thereof) or colloidal suspension or the like. The particle diameter (D50) of the conductive powder can be about 0.5 to about 12 μm in one embodiment, about 1 to about 10.5 μm in another embodiment, and about 1.3 to about 9.5 μm in another embodiment. The particle diameter (D50) can be measured by laser diffraction scattering method with Microtrac model S-3500. Mixtures of metals having different average particle sizes, particle size distributions or shapes, and etc. can also be employed.

Specific surface area (SA) of the conductive powder can be about 1.5 to about 8 m²/g in one embodiment, about 1.9 to about 6.9 m²/g in another embodiment and about 2.2 to about 5.5 m²/g in another embodiment. The specific surface area can be measured by BET method with Monosorb™ from Quantachrome Instruments Corporation.

In one embodiment of the present disclosure, the conductive material is present in an amount of about 50 wt. % to about 80 wt. % of the conductive paste, such as from about 55 wt. % to about 70 wt. % of the conductive paste, such as from about 60 wt. % to about 75 wt. % of the conductive paste. In embodiments, the conductive material is present in an amount of about 50 wt. % to about 65 wt. % of the conductive paste. In other embodiments, the conductive material is present in an amount of about 60 wt. % to about 80 wt. % of the conductive paste.

b. Glass Frit

The conductive paste of the present disclosure includes glass frit. The glass frit can include particles of glass in the form of powder (for example, spherical shape, flakes, irregular form and/or the mixture thereof). The conductive paste can include from about 1 wt. % to about 25 wt. % of glass frit, such as about 5 wt. % to about 15 wt. % of glass frit, such as from about 2 wt. % to about 20 wt. %. In embodiments, the conductive paste can include from about 1 wt. % to about 10 wt. % of glass frit. In other embodiments, the conductive paste can include from about 10 wt. % to about 25 wt. % of glass frit.

The glass frit can include metal oxides. For example, in embodiments the glass frit can include a transition metal oxide. Suitable transition metal oxides include those that can be formed from oxygen and one or more transition metals. For instance, suitable transition metal oxides can include vanadium oxides, in particular vanadium pentoxide (V₂O₅). In embodiments, the glass frit contains only one transition metal oxide that includes vanadium pentoxide (V₂O₅). In another embodiment, the glass frit contains only two transition metal oxides that include V₂O₅ and tungsten oxide (WO₃). The glass frit can include from about 15 wt. % to about 30 wt. % of V₂O₅ based on the total weight of the glass frit, such as from about 18 wt. % to about 28 wt. % of V₂O₅, such as from about 20 wt. % to about 25 wt. % of V₂O₅. In embodiments, the glass frit includes about 15 wt. % to about 25 wt. % of V₂O₅. In other embodiments, the glass frit includes about 20 wt. % to about 30 wt. % of V₂O₅. In certain embodiments, the glass frit includes from about 6 wt. % to about 10 wt. % of WO₃ based on the total weight of the glass frit, such as about 7 wt. % to about 8 wt. %, such as about 7.5 wt. % to about 8.4 wt. %.

In such embodiments, the glass frit is substantially free from all other transition metal oxides. Non-limiting examples of such transition metal oxides include scandium oxides, titanium oxides (e.g., titanium dioxide (TiO₂)), chromium oxides, magnesium oxides, iron oxides, cobalt oxides, nickel oxides, copper oxides, zine oxides, yttrium oxides, zirconium oxides, niobium oxides, molybdenum oxides, technetium oxides, ruthenium oxides, rhodium oxides, palladium oxides, silver oxides, cadmium oxides, hafnium oxides, tantalum oxides, tungsten oxides, rhenium oxides, osmium oxides, iridium oxides, platinum oxides, gold oxides, mercury oxides, rutherfordium oxides, dubnium oxides, seaborgium oxides, bohrium oxides, hassium oxides, and combinations or mixtures thereof. Specifically, in embodiments, the glass frit does not include any transition metal oxide that forms a cationic species, such as zinc oxide. For instance, the present inventors have discovered that use of the specific combination of oxides yields a glass frit contributing to superior acid resistant properties as compared to other formulations. Such acid resistant properties are useful for end-uses on batteries, such as for use as terminal electrodes on solid state batteries.

In embodiments, the glass frit includes a metalloid oxide. For instance, the glass frit can include tellurium oxide (TeO₂). In embodiments, the only metalloid oxide present in the glass frit is tellurium oxide. In other embodiments, the only metalloid oxides present in the glass frit include TeO₂ and silicon dioxide (SiO₂). In other embodiments, the glass frit is substantially free from boron oxides, silicon oxides, germanium oxides, arsenic oxides, antimony oxides, and mixtures thereof. The TeO₂ can be present in an amount of about 40 wt. % to about 70 wt. % based on the total weight of the components of the glass frit, such as about 45 wt. % to about 65 wt. %, such as about 50 wt. % to about 60 wt. %. In embodiments, the TeO₂ can be present in an amount of about 40 wt. % to about 60 wt. %. In other embodiments, TeO₂ can be present in an amount of about 50 wt. % to about 70 wt. %. In embodiments, SiO₂ is present in an amount of about 1 wt. % to about 5 wt. % based on the total weight of the glass frit, such as about 2 wt. % to about 4 wt. %, such as about 2 wt. % to about 3 wt. %.

The glass frit can include one or more post-transition metal oxides. Suitable post-transition metal oxides can include aluminum oxides (e.g., Al₂O₃), bismuth oxides (e.g., Bi₂O₃), and combinations or mixtures thereof. In embodiments, the glass frit can be substantially free from other post-transition metal oxides, except for aluminum oxides and bismuth oxides. For instance, the glass frit can be substantially free from gallium oxides, indium oxides, tin oxides, thallium oxides, lead oxides, polonium oxides, astatine oxides, and mixtures or combinations thereof.

The glass frit can include about 10 wt. % to about 30 wt. % of Bi₂O₃ based on the total weight of the glass frit, such as about 15 wt. % to about 25 wt. %, such as from about 12 wt. % to about 20 wt. %. In embodiments, the glass frit can include about 20 wt. % to about 30 wt. % of Bi₂O₃ based on the total weight of the glass frit. The glass frit can include from about 1 wt. % to about 12 wt. % of Al₂O₃ based on the total weight of the glass frit, such as from about 5 wt. % to about 10 wt. %, such as from about 7 wt. % to about 12 wt. %. In embodiments, the glass frit can include about 1 wt. % to about 5 wt. % of Al₂O₃ based on the total weight of the glass frit. In other embodiments, the glass frit can include about 5 wt. % to about 12 wt. % of Al₂O₃ based on the total weight of the glass frit.

In certain embodiments, the glass frit can include an alkali metal oxide. Suitable alkali metal oxides include lithium oxides, sodium oxides, potassium oxides, and rubidium oxides. In an embodiment, the glass frit can include lithium oxide (Li₂O) and be substantially free from all other alkali metal oxides. When present the alkali metal oxide is present in the glass frit in amount of about 0.1 wt. % to about 2 wt. %, such as about 0.5 wt. % to about 2 wt. %, such as about 0.6 wt. % to about 1 wt. %. In other embodiments, the glass frit is substantially free from alkali metal oxide.

In embodiments, the glass frit includes a combination of metal oxides including vanadium pentoxide, tellurium oxide, bismuth oxide, and aluminum oxide. Without being bound by any theory, after printing on the surface of an article and firing, the glass frit composition as described increases the adhesiveness and original strength of the conductive paste while providing for increased acid resistance for the fired paste.

As noted above, in embodiments, the glass frit is a lead-free glass frit that does not contain lead or a lead component. Specifically, the glass frit is substantially free of any lead and the derivatives thereof (for example, lead oxides, such as lead monoxide (PbO), lead dioxide (PbO₂) or lead tetroxide (Pb₃O₄), and the like).

The softening point of the glass frit can be from about 200 to about 500° C., such as from about 200 to about 400° C., such as from about 250 to about 400° C., such as from about 200 to about 300° C.

The particle diameter (D50) of the glass frit can be from about 0.1 to 15 μm, such as about 0.5 to about 11 μm, such as 1.0 to 6.8 μm, such as from about 1.5 to 4.5 μm in another embodiment. In other embodiments, the particle diameter of the glass frit can be from about 0.1 to about 10 μm or from about 5 μm to about 15 μm. The particle diameter (D50) can be measured by laser diffraction scattering method with Microtrac model S-3500.

c. Organic Vehicle

The conductive paste can include an organic vehicle. For instance, the conductive material and glass frit can be mixed with the organic vehicle to form a conductive paste. The organic vehicle can be in a liquid or viscous form to facilitate mixing. Suitable organic vehicles allow the conductive material and glass frit to be uniformly dispersed therein and have a proper viscosity to deliver said the conductive material and glass frit to the surface of an article such as by screen printing, stencil printing or the like. The conductive paste as provided also provides a good drying rate and excellent burn-out properties even at lower firing temperatures (e.g., those under) 450°.

The organic vehicle can include an organic polymer and a solvent. A variety of inert viscous materials can be used as an organic polymer. The organic polymer can be selected from the group consisting of ethyl cellulose, ethylhydroxyethyl cellulose, wood rosin, phenolic resin, polymethacrylate of lower alcohol, monobutyl ether of ethylene glycol monoacetate and a mixture thereof. The organic polymer can be present in an amount of from about 5 wt. % to about 40 wt. %, such as from about 10 wt. % to about 30 wt. %, such as from about 6 wt. % to about 20 wt. %, such as from about 20 wt. % to about 40 wt. %, based on the total weight of the organic vehicle.

The solvent can be selected from the group consisting of texanol, ester alcohol, terpineol, kerosene, dibutylphthalate, butyl carbitol, butyl carbitol acetate, dibutyl carbitol, hexylene glycol, dibasic ester and a mixture thereof. The solvent is chosen in view of organic polymer solubility. The solvent can be present in an amount of about 60 wt. % to about 95 wt. %, such as from about 50 wt. % to about 85 wt. %, such as from about 60 wt. % to about 75 wt. %, such as from about 70 wt. % to about 95 wt. %, such as from about 80 wt. % to about 95 wt. %, based on the total weight of the organic vehicle. In an embodiment, the organic vehicle includes a mixture of ethyl cellulose and texanol.

The organic vehicle can optionally include an organic additive. The organic additive can be one or more of a thickener, stabilizer, viscosity modifier, surfactant, wetting agent, thixotropic agent, and other conventional additives (for example colorants, preservatives, or oxidants), etc. The amount of the organic additive depends on the desired characteristics of the resulting electrically conductive paste. The selected additives are not subject to limitation as long as they do not adversely affect the technical effect of the present disclosure.

d. Resistivity

The conductive paste of the present disclosure can have a resistivity of from about 3.5 mohm/sq. to less than about 8 mohm/sq. when fired at a temperature of less than about 450° C. In embodiments, the conductive paste can have a resistivity of from about 3.7 mohm/sq. to about 7 mohm/sq., such as from about 4 mohm/sq. to about 6 mohm/sq., such as from about 4 mohm/sq. to about 5 mohm/sq., when fired a temperature of less than about 450° C. In other embodiments, the conductive paste can have a resistivity of from about 4 mohm/sq. to about 7.5 mohm/sq., such as from about 4.2 mohm/sq. to about 6.3 mohm/sq., such as from about 4.4 to about 5.1 mohm/sq., when fired at a temperature of about 450° C. In other embodiments, the conductive paste can have a resistivity of from about 4 mohm/sq. to about 6.5 mohm/sq., such as from about 4 mohm/sq. to about 6 mohm/sq., such as from about 4.9 mohm/sq. to about 5.6 mohm/sq., when fired at a temperature of about 400° C. In other embodiments, the conductive paste can have a resistivity of about 5.5 mohm/sq. to about 7.5 mohm/sq., such as from about 6.1 mohm/sq. to about 6.6 mohm/sq., such as from about 5.8 mohm/sq. to about 7.2 mohm/sq., when fired at a temperature of about 350° C.

Resistivity can be measured according to the following method. Conductive paste is disposed in a serpentine line pattern on an alumina substrate containing 96% wt. % of Al₂O₃. The line pattern has a width of 0.5 mm, a length of 135.5 mm, and a thickness of 10 μm. The line pattern is then dried in a box oven at a temperature of 150° C. for about 10 minutes. The line pattern is then fired at a firing temperature for 10 minutes in a box oven. The resistivity of the line pattern is then measured with a digital multimeter (Model 2100, Keithley Instruments, Inc).

e. Acid Resistance

In embodiments, the conductive paste of the present disclosure is acid resistant. As used herein, “acid resistant” refers to an acid resistant test whereby nine (9) 2×2 mm squares of conductive paste are printed on to an alumina substrate containing 96 wt. % of Al₂O₃. Each square has a width of 2 mm, a length of 2 mm, and a thickness of 10 μm. The squares are then dried at a temperature of 150° C. for 10 minutes in a box oven. The squares are fired at a firing temperature for 10 minutes in a box oven. After firing, the substrate is submersed in a sulfonic acid tin plating solution having a pH of about 1 for 5 minutes. The sulfonic acid tin plating solution is at a temperature of about 18 to 24° C. The substrate containing the squares is then removed from the plating solution and washed with distilled water. Once dry, each square is exposed to tape (e.g., Scotch® Tape) and the resulting number of squares peeled from the alumina substrate is counted.

A conductive paste is considered “acid resistant” where less than 4 squares, such as less than 3 squares, such as less than 2 squares, such as less than 1 squares, such as 0 squares, are peeled off from the substrate. In other words, a conductive paste can be “acid resistant” where less than 35 wt. % of the fired conductive paste, such as less than about 20 wt. %, such as less than about 10 wt. %, such as less than about 5 wt. %, such less than about 1 wt. %, such as about 0 wt. %, is removed from an alumina substrate by tape (e.g., Scotch® Tape) after exposure to a sulfonic acid tin plating solution having a pH of 1 and a temperature of about 18 to 24° C. for time period of about 5 minutes.

### II. Articles

The conductive paste can be applied to one or more articles and fired forming a conductive layer thereon. Notably, the conductive paste of the present disclosure can be applied to the article and then fired, forming a conductive layer on the article. For instance, the conductive paste can be utilized in a wide array of applications (e.g., batteries, solar, etc.) where a lower firing temperature is desirable. For instance, the conductive paste of the present disclosure can be fired at temperatures under 450° C., while maintaining excellent adhesion and acid resistant properties as described in the Examples provided hereinbelow.

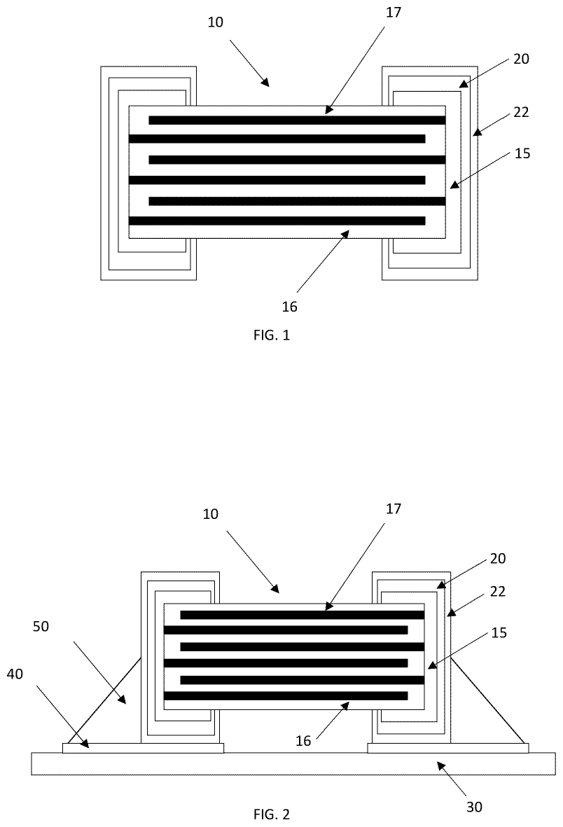

Given that the conductive paste is acid resistant, in embodiments, the conductive paste can be used on an article that is a battery, such as a solid-state battery. In embodiments, the conductive paste can be utilized on a solid state battery 10 to form one or more terminal electrodes 15. For instance, as shown in FIG. 1, the conductive paste can be applied and fired to produce the terminal electrodes 15 as shown. For instance, the solid state battery 10 can include one or more electrolyte layers 16, one or more inner electrodes 17, in a stacked arrangement as shown. Each electrolyte layer 16 and inner electrode layer 17 have ends that can be coupled to the terminal electrodes 15. In practice, the conductive paste can be applied to the ends of the electrolyte layers 16 and inner electrode layers 17 and fired to produce the terminal electrodes 15. Additional plating layers (e.g., a first plating layer 20 and second plating layer 22) can be placed on the outer surface of the terminal electrodes 15 as shown. The plating layers 20,22 can include conductive materials, such as metals. In embodiments, the plating layers include nickel, tin, or combinations thereof.

To form the plating layers 20,22 on the battery 10, the process generally requires an electroplating process to deposit the nickel and tin materials on the terminal electrodes 15. Such electroplating processes are conducted under acidic conditions and require exposing components of the battery 10 to a pH of from about 1-4. Thus, the conductive paste of the present disclosure, which provides superior acid resistance properties once fired, can be utilized for terminal electrode formation given their acid resistant properties.

The solid state battery 10 can be surface mounted to a suitable substrate 30, as shown in FIG. 2. The substrate material can include any conductive, dielectric, or insulative material. Suitable substrates include printed circuit boards. Further, as shown in FIG. 2 one or more mounting pads 40 can be disposed between the article 10 and the substrate 30. The article 10 can be placed on the mounting pads 40 and solder 50 can be applied to securely couple the article to the substrate 30.

### III. Methods

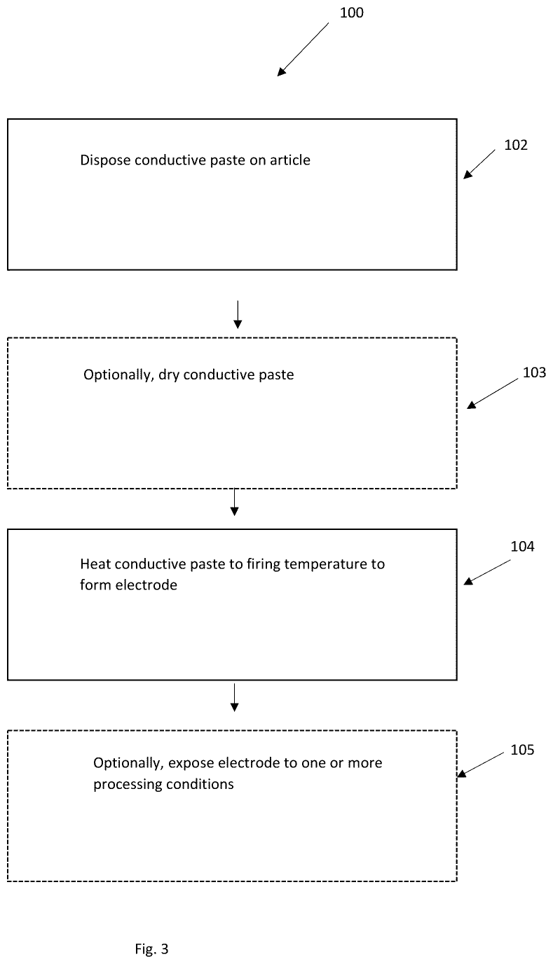

FIG. 3 depicts a flow diagram of one example method of forming an article (100) according to the present disclosure.

At (102), the method includes disposing a conductive paste on the article. The conductive paste can include a conductive material and glass frit dispersed within an organic vehicle. The conductive paste can include materials described herein. In embodiments, the conductive material can include a metal, such as silver. The glass frit can include a variety of metal oxides. In embodiments, the glass frit includes V₂O₅, TeO₂, Bi₂O₃, and Al₂O₃. V₂O₅ can be present in an amount of from about 15 wt. % to about 30 wt. % based on the total weight of the glass frit. The organic vehicle can include a polymer and solvent. The organic vehicle can include from about 5 wt. % to about 40 wt. % of a polymer and about 60 wt. % to about 95 wt. % of a solvent based on the total weight of the organic vehicle. The conductive paste can include from about 20 wt. % to about 40 wt. %, such as about 28 wt. % of the organic vehicle, from about 50 wt. % to about 70 wt. % of the conductive material, such as about 62 wt. % of conductive material, and from about 5 wt. % to about 15 wt. %, such as about 10 wt. % of the glass frit.

In embodiments, the conductive paste can be disposed on one or more components of a battery (e.g., solid state battery) as disclosed. For instance, the conductive paste can be disposed on one or more of the electrolyte layers, electrodes, or other structures on a solid state battery.

Optionally, at (103), the method includes drying the conductive paste prior to firing. For instance, the conductive paste can be dried in an oven for a desired amount of time at a drying temperature. The drying temperature can range from about 100° C. to about 200° C., such as about 150° C. The drying time can also vary from about 5 minutes to about 1 hour, from about 10 minutes to about 50 minutes, from about 15 minutes to about 45 minutes, from about 20 minutes to about 40 minutes, and/or about 30 minutes. The drying can be completed in any suitable oven or heater.

At (104), the method includes heating the conductive paste to a firing temperature. In embodiments, the firing temperature can range from about 350° C. to about 600° C. However, in embodiments the firing temperature is less than about 450° C. The conductive paste can be heated for firing for a time ranging from about 5 minutes to about 1 hour, from about 10 minutes to about 50 minutes, from about 15 minutes to about 45 minutes, from about 20 minutes to about 40 minutes, and/or about 30 minutes. In embodiments, the firing time is about 10 minutes. The firing can be completed in any suitable oven or heater. After firing, an electrode is formed from the conductive paste on the article.

In embodiments, the electrode formed from the conductive paste is formed on a solid state battery and can be the terminal electrode. In such an embodiment, given the solid electrolyte material and other inner electrode layers, it is desirable not to expose the other material to high firing temperatures, such as those exceeding 600° C. As such, at (104), the firing temperature can include temperatures under 450° C., such that additional heat exposure to other components on or within the solid state battery are minimized, which can reduce material alteration or degradation of other battery materials.

Optionally, at (105), the method includes exposing the electrode formed from the conductive paste to an additional processing condition. For instance, where the conductive paste is used to form a terminal electrode for a battery, the electrode can be exposed to additional electroplating processing. Such processing can expose the formed electrode to a low pH environment, such as an environment having a pH between 1 and 4. Additionally, the electrode can be exposed to further sintering or firing steps, to sinter or fire other material layers on the article. In such embodiments, the electrode can be exposed to further firing steps having firing temperatures ranging from about 220° C. to about 600° C. for time periods ranging from about 5 minutes to about 1 hour.

In embodiments, even after exposure to low pH (from about 1 to 4) environments or other firing annealing temperatures (ranging from 220 to 600° C.), the electrode formed from the conductive paste still exhibits excellent adhesion to components on the article (e.g., battery) as compared to electrodes formed from conductive pastes of other materials. Such results are further exemplified in the Examples below.

Further, the article including the electrode can be exposed to soldering. In such embodiments, the electrode can be exposed to soldering having soldering temperatures ranging from about 220° C. to about 260° C. for time periods ranging from about 20 seconds to about 40 seconds. In such an embodiment, the article containing the electrode formed from the conductive paste disclosed herein can be coupled to a substrate (e.g., a printed circuit board).

### Test Methods

The following methods can be utilized according to the present disclosure.

### Resistivity Test

Resistivity of conductive pastes of the present disclosure can be measured according to the following method. Conductive paste is disposed (e.g., printed) in a serpent line pattern on an alumina substrate containing 96 wt. % of Al₂O₃. The serpent line pattern has a width of 0.5 mm, a length of 135.5 mm, and a thickness of 10 μm. The line pattern is then dried at 150° C. for 10 minutes in a box oven. After drying, the line pattern is fired at a firing temperature for 10 minutes in a box oven. After firing, the resistivity of the line pattern is then measured with a digital multimeter (Model 2100, Keithley Instruments, Inc).

### Acid Resistance Test

Acid resistance of conductive pastes of the present disclosure can be measured according to the following method. Nine (9) 2×2 mm squares of conductive paste are printed on to an alumina substrate containing 96 wt. % of Al₂O₃. Each square has a width of 2 mm wide, a length of 2 mm, and a thickness of 10 μm. The squares are then dried at 150° C. for 10 minutes in a box oven. After drying, the squares are fired in a box oven for 10 minutes at a firing temperature. Firing temperatures can range from about 350° C. to about 600° C. After firing, the substrate is submersed in a sulfonic acid tin plating solution having a pH of about 1 and a temperature of about 18 to 24° C. for 5 minutes. The substrate containing the squares is then removed from the plating solution and washed with distilled water. Once dry, each square is exposed to tape (e.g., Scotch® Tape) and the resulting number of squares peeled from the alumina substrate is counted.

### Examples

The present disclosure is further illustrated by, but is not limited to, the following examples.

Comparative examples (C1-C3) and experimental examples (E1-E9) of glass frit were prepared according to Table 1 below.

TABLE 1

| | Wt. % | | | | | | | | | | |
|---|---|---|---|---|---|---|---|---|---|---|---|
| Ex. | PbO | SiO₂ | B₂O₃ | Bi₂O₃ | Al₂O₃ | ZnO | BaO | V₂O₅ | TeO₂ | WO₃ | Li₂O |
| C1 | 78.1 | 5.4 | 12.4 | — | 4.1 | — | — | — | — | — | — |
| C2 | 80.5 | 6.0 | 12.0 | — | — | 1.5 | — | — | — | — | — |
| C3 | — | 1.0 | 9.5 | 73.0 | 0.5 | 13.0 | 3.0 | — | — | — | — |
| E1 | — | — | | 26.6 | 5.3 | — | — | 25.5 | 42.6 | — | — |
| E2 | — | — | | 26.9 | 1.7 | — | — | 17.3 | 54.1 | — | — |
| E3 | — | — | | 19.0 | 1.7 | — | — | 17.3 | 54.2 | 7.9 | — |
| E4 | — | — | | 20.2 | 3.7 | — | — | 18.4 | 57.7 | — | — |
| E5 | — | — | | 11.8 | 3.7 | — | — | 18.4 | 57.7 | 8.4 | — |
| E6 | — | — | | 12.6 | 5.9 | — | — | 19.7 | 61.8 | — | — |
| E7 | — | — | | 12.3 | 5.8 | — | — | 15.8 | 66.2 | — | — |
| E8 | — | — | | 13.0 | 6.1 | — | — | 16.7 | 63.6 | — | 0.6 |
| E9 | — | — | | 12.6 | 3.9 | — | — | 19.6 | 61.5 | — | — |

Silver powders and glass frit (C1-C3 and E1-E9) were dispersed in an organic vehicle in a mixer and homogenized by a three-roll mill. The silver powder was a mixture of a first Ag powder (particle diameter (D50): about 0.8 μm, SA: about 0.9 m²/g) and a second Ag powder (particle diameter (D50): about 1.6 μm, SA: about 0.7 m²/g). The organic vehicle was a mixture of 9 wt. % of a polymer and 91% of a solvent based on the weight of the organic vehicle. The conductive paste included about 28 wt. % of the organic vehicle, 62% of conductive material, and 10% glass frit.

The conductive pastes having the comparative and experimental glass frits were screen printed on an alumina substrate (25 mm long, 25 mm wide, 0.6 mm thick) in a square pattern to test for initial adhesion and acid resistance. The pattern included nine squares with each square having a width of 2 mm wide, a length of 2 mm, and a thickness of 10 μm. After printing, the squares were dried in a box oven at a temperature of 150° C. for about 10 minutes. The squares were then fired at various firing temperatures including 350° C., 400° C., 450° C., and 600° C. for 10 minutes in the box oven. Prior to acid exposure, all nine of the squares were then exposed to Scotch® tape, which was then peeled off by hand. The number of squares that peeled off with the Scotch® tape out of nine was then counted. The initial adhesion results are shown in Tables 2-5.

The acid resistance of the square patterns was also measured. To measure acid resistance, the alumina substrate with the square patterns was dipped into a sulfonic acid tin plating solution of pH 1 for 5 minutes. The alumina substrate was taken out and dried. All nine squares were then exposed to Scotch® tape, which was then peeled off by hand. The number of squares that peeled off with the Scotch® tape of nine was counted. The acid resistance results are shown in Tables 2-5.

The resistivity (Rs) of the conductive pastes was also measured to see if the materials could have sufficiently low resistivity. The conductive pastes were printed in a serpentine line pattern on an alumina substrate. The line pattern was 0.5 mm wide, 135.5 mm long and 10 μm thick. After printing, the line patterns were dried in a box oven at a temperature of 150° C. for about 10 minutes. The line patterns were then fired at various firing temperatures including 350° C., 400° C., 450° C., and 600° C. for 10 minutes in the box oven. The resistivity of the line patterns was measured with a digital multimeter (Model 2100, Keithley Instruments, Inc.). The results are shown in Tables 2-5.

TABLE 2
350° C. Firing

| | | Initial | Acid |
|---|---|---|---|
| Category | Rs(mohm/sq.) | Adhesion | Resistance |
| C1 | 12.5 | 5/9 | 9/9 |
| C2 | 11.1 | 8/9 | 9/9 |
| C3 | 11.7 | 9/9 | 9/9 |
| E1 | 6.5 | 0/9 | 0/9 |
| E2 | 5.8 | 0/9 | 0/9 |
| E3 | 7.2 | 0/9 | 0/9 |
| E4 | 6.6 | 0/9 | 0/9 |
| E5 | 6.3 | 0/9 | 0/9 |
| E6 | 5.8 | 0/9 | 0/9 |
| E7 | 6.4 | 0/9 | 0/9 |
| E8 | 5.7 | 0/9 | 0/9 |
| E9 | 6.1 | 0/9 | 0/9 |

TABLE 3
400° C. Firing

| | | Initial | Acid |
|---|---|---|---|
| Category | Rs(mohm/sq.) | Adhesion | Resistance |
| C1 | 5.8 | 0/9 | 9/9 |
| C2 | 4.9 | 0/9 | 9/9 |
| C3 | 6.6 | 0/9 | 9/9 |
| E1 | 6.3 | 0/9 | 0/9 |
| E2 | 5.3 | 0/9 | 0/9 |
| E3 | 5.6 | 0/9 | 0/9 |
| E4 | 5.3 | 0/9 | 0/9 |
| E5 | 5.4 | 0/9 | 0/9 |
| E6 | 5.5 | 0/9 | 0/9 |
| E7 | 4.9 | 0/9 | 0/9 |
| E8 | 5.2 | 0/9 | 0/9 |
| E9 | 5.5 | 0/9 | 0/9 |

TABLE 4
450° C. Firing

| | | Initial | Acid |
|---|---|---|---|
| Category | Rs(mohm/sq.) | Adhesion | Resistance |
| C1 | 3.1 | 0/9 | 9/9 |
| C2 | 3.1 | 0/9 | 9/9 |
| C3 | 3.5 | 0/9 | 9/9 |
| E1 | 4.6 | 0/9 | 0/9 |
| E2 | 4.3 | 0/9 | 0/9 |
| E3 | 6.3 | 0/9 | 0/9 |
| E4 | 4.4 | 0/9 | 0/9 |
| E5 | 5.1 | 0/9 | 0/9 |
| E6 | 5.1 | 0/9 | 0/9 |
| E7 | 4.1 | 0/9 | 0/9 |
| E8 | 4.8 | 0/9 | 0/9 |
| E9 | 7.2 | 0/9 | 0/9 |

TABLE 5
600° C. Firing

| | | Initial | Acid |
|---|---|---|---|
| Category | Rs(mohm/sq.) | Adhesion | Resistance |
| C1 | 2.5 | 0/9 | 9/9 |
| C2 | 2.4 | 0/9 | 9/9 |
| C3 | 2.9 | 0/9 | 0/9 |
| E1 | 3.7 | 0/9 | 0/9 |
| E2 | 4.2 | 0/9 | 3/9 |
| E3 | 5.7 | 0/9 | 0/9 |
| E4 | 4.2 | 0/9 | 0/9 |
| E5 | 5.1 | 0/9 | 0/9 |
| E6 | 5.3 | 0/9 | 0/9 |
| E7 | 4.4 | 0/9 | 0/9 |
| E8 | 4.5 | 0/9 | 0/9 |
| E9 | 6.1 | 0/9 | 9/9 |

The number of peeled-off squares was drastically lower in the experimental examples as compared to the comparative examples after acid exposure. The resistivity of the experimental examples stayed acceptably low as compared to the comparative examples. Further, at firing temperatures under 450° C., all the comparative examples (C1-C3) peeled off after acid exposure, whereas none of the experimental examples (E1-E9) peeled off after acid exposure.

### Definitions

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

As used herein, “optional” or “optionally” means that the subsequently described event or circumstance does or does not occur, and that the description includes instances where said event or circumstance occurs and instances where it does not. For example, an optional component in a method or composition means that the component may be present or may not be present in the method or composition.

As used herein, “adhesion” refers to the property of a surface of a material to stick or bond to the surface of another material. Adhesion can be measured by the Scotch® tape test as disclosed herein or by any other acceptable test (e.g., by ASTM D3359-08).

As used herein, the term “substantially free” means no more than an insignificant trace amount present and encompasses completely free (e.g., 0 molar % up to 0.01 molar %).

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

All references to singular characteristics or limitations of the present disclosure shall include the corresponding plural characteristic or limitation, and vice versa, unless otherwise specified or clearly implied to the contrary by the context in which the reference is made.

The methods and compositions of the present disclosure, including components thereof, can comprise, consist of, or consist essentially of the essential elements and limitations of the disclosure described herein.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed is:

1. A conductive paste, comprising:
a conductive material;
a glass frit comprising V₂O₅, TeO₂, Bi₂O₃, and Al₂O₃, wherein V₂O₅ is present in an amount of from about 15 wt. % to about 30 wt. % based on the total weight of the glass frit; and
an organic vehicle.

2. The conductive paste of claim 1, wherein the glass frit comprises from about 40 wt. % to about 70 wt. % of TeO₂.

3. The conductive paste of claim 1, wherein the glass frit comprises 10 wt. % to 30 wt. % of Bi₂O₃.

4. The conductive paste of claim 1, wherein the glass frit comprises from about 1 wt. % to about 12 wt. % of Al₂O₃.

5. The conductive paste of claim 1, wherein the conductive material comprises metal.

6. The conductive paste of claim 5, wherein the metal comprises silver.

7. The conductive paste of claim 1, wherein the organic vehicle comprises a organic polymer and an alcohol.

8. The conductive paste of claim 1, wherein the organic polymer comprises ethyl cellulose.

9. The conductive paste of claim 1, comprising from about 55 wt. % to about 70 wt. % of the conductive material.

10. The conductive paste of claim 1, comprising from about 5 wt. % to about 15 wt. % of the glass frit.

11. The conductive paste of claim 1, comprising from about 20 wt. % to about 40 wt. % of the organic vehicle.

12. The conductive paste of claim 1, wherein the paste is substantially free of lead.

13. The conductive paste of claim 1, wherein the paste is substantially free from one or more additional transition metal oxides.

14. The conductive paste of claim 1, wherein the conductive paste exhibits a resistivity of about 3.5 mohm/sq. to less than about 8 mohm/sq. when fired at a temperature less than 450° C.

15. An article comprising a battery wherein the conductive paste of claim 1 is applied to the battery to form one or more terminal electrodes.

16. A method for forming an article comprising a terminal electrode for a battery, the method comprising:
disposing a conductive paste on the article, the conductive paste comprising:
a conductive material;
a glass frit comprising V₂O₅, TeO₂, Bi₂O₃, and Al₂O₃, wherein V₂O₅ is present in an amount of from about 15 wt. % to about 30 wt. %; and
an organic vehicle; and
heating the conductive paste to a firing temperature less than about 450° C.

17. The method of claim 16, wherein the glass frit comprises from about 40 wt. % to about 70 wt. % of TeO₂.

18. The method of claim 16, wherein the glass frit comprises 10 wt. % to 30 wt. % of Bi₂O₃.

19. The method of claim 16, wherein the glass frit comprises from about 1 wt. % to about 12 wt. % of Al₂O₃.

20. The method of claim 16, wherein the conductive material comprises silver.
